(19) United States
(12) Patent Application Publication
(10) Pub. No.: US 2026/0043651 A1
(43) Pub. Date: Feb. 12, 2026

(54) FULLY-DECOUPLED THREE-AXIS MEMS GYROSCOPE AND ELECTRONIC PRODUCT

(71) Applicant: AAC Kaitai Technologies (Wuhan) CO., LTD., Wuhan (CN)

(72) Inventors: Zhao Ma, Wuhan (CN); Zhan Zhan, Wuhan (CN); Xiao Kan, Wuhan (CN); Shitao Yan, Wuhan (CN); Shan Yang, Wuhan (CN); Lingcheng Kong, Wuhan (CN); Yang Li, Wuhan (CN); Kahkeen Lai, Singapore (SG); Qiuyu Tan, Singapore (SG)

(21) Appl. No.: 19/006,270

(22) Filed: Dec. 31, 2024

Related U.S. Application Data
(63) Continuation of application No. PCT/CN2024/110173, filed on Aug. 6, 2024.

(51) Int. Cl. G01C 19/5733

(52) U.S. Cl. CPC G01C 19/5733

(57) ABSTRACT

Provided are a fully-decoupled three-axis MEMS gyroscope and an electronic product. The gyroscope includes a substrate, an X/Y proof mass, Z proof masses, driving structures, and Z decoupled masses fixed to the substrate. The X/Y proof mass is annularly arranged outside the Z proof masses, the driving structures, and the Z decoupled masses; the X/Y proof masses are arranged oppositely along an x-axis direction; the driving structures are arranged oppositely along the x-axis direction outside the Z proof masses; and the Z decoupled masses are arranged oppositely along the x-axis direction at inner sides of the Z proof masses. The X/Y proof mass is elastically connected to the driving structures adjacent thereto, each Z proof mass is elastically connected to one driving structure adjacent thereto, and each Z decoupled mass is elastically connected to one Z proof mass adjacent thereto. The gyroscope has improved detection precision.

### TECHNICAL FIELD

Embodiments of the present disclosure relate to the technical field of gyroscopes, and in particular, to a fully-decoupled three-axis Micro-Electro-Mechanical System (MEMS) gyroscope and an electronic product.

### BACKGROUND

MEMS gyroscope is a miniature angular velocity sensor manufactured by applying micromachining technology and microelectronic processes.

MEMS out-of-plane oscillating gyroscope is a typical representation of MEMS out-of-plane detection gyroscopes. The driving mode of the MEMS oscillating gyroscope oscillates about the axis of a perpendicular mass. When applying angular velocity Ω, the gyroscope transfers energy to a sensitive mode due to the Coriolis effect, causing a vibrating disk to oscillate out-of-plane in relative driving. The magnitude of Ω can be obtained by detecting the displacement of the out-of-plane oscillation.

In the related art, for the MEMS gyroscope, an X/Y proof mass is centrally arranged, and Z proof masses and driving members are arranged outside the X/Y proof mass, which results in low efficiency of the Coriolis force transformation of the X/Y mass and low utilization rate of chip area. In addition, Z-axis detection is not decoupled, resulting in large orthogonal error.

In view of the above problems, it is necessary to propose a fully-decoupled three-axis MEMS gyroscope and an electronic product which are well-designed and can effectively address the above problems.

### SUMMARY

Embodiments of the present disclosure aim to solve at least one of the technical problems existing in the related art and provide a fully-decoupled three-axis MEMS gyroscope and an electronic product.

An aspect of the embodiments of the present disclosure provides a fully-decoupled three-axis Micro-Electro-Mechanical System (MEMS) gyroscope including: a substrate, an X/Y proof mass, a plurality of Z proof masses, a plurality of driving structures, and a plurality of Z decoupled masses respectively fixed to the substrate,
where the X/Y proof mass is annularly arranged outside the plurality of Z proof masses, the plurality of driving structures, and the plurality of Z decoupled masses; the plurality of Z proof masses are arranged oppositely along an x-axis direction; the plurality of driving structures are arranged oppositely along the x-axis direction outside the plurality of Z proof masses; and the plurality of Z decoupled masses are arranged oppositely along the x-axis direction at inner sides of the plurality of Z proof masses; and
where the X/Y proof mass is elastically connected to the driving structures adjacent thereto, each of the Z proof masses is elastically connected to one of the driving structures adjacent thereto, and each of the Z decoupled masses is elastically connected to one of the Z proof masses adjacent thereto.

As an improvement, the X/Y proof mass is symmetrically arranged with respect to each of the x-axis direction and a y-axis direction;
the plurality of Z proof masses arranged oppositely are symmetrically distributed with respect to the y-axis direction, and each of the Z proof masses is symmetrically distributed with respect to the x-axis direction;
the plurality of driving structures arranged oppositely are symmetrically distributed with respect to each of the x-axis direction and the y-axis direction; and
the plurality of Z decoupled masses arranged oppositely are symmetrically distributed with respect to each of the x-axis direction and the y-axis direction.

As an improvement, the fully-decoupled three-axis MEMS gyroscope further includes a plurality of X/Y out-of-detection plane electrodes, a plurality of Z in-detection plane electrodes, and a plurality of in-plane driving electrodes;
the plurality of X/Y out-of-detection plane electrodes are arranged along the x-axis direction and the y-axis direction, respectively, on one side of the X/Y proof mass facing away from the substrate;
each of the Z in-detection plane electrodes is arranged on one side of one of the Z-decoupled masses corresponding thereto facing away from the substrate; and
each of the in-plane driving electrodes is arranged on one side of one of the driving structure corresponding thereto facing away from the substrate.

As an improvement, the fully-decoupled three-axis MEMS gyroscope further includes first coupling beams, second coupling beams, and first connecting beams;
each of the Z proof masses is elastically connected to one of the driving structures adjacent thereto through the first coupling beams;
the X/Y proof mass is elastically connected to the driving structures adjacent thereto through the second coupling beams; and
each of the Z decoupled masses is elastically connected to one of the Z proof masses adjacent thereto through one of the first connecting beams.

As an improvement, the fully-decoupled three-axis MEMS gyroscope further includes a plurality of coupling blocks, a plurality of third coupling beams, a plurality of fourth coupling beams, and a plurality of first anchors fixed to the substrate;
the plurality of coupling blocks and the plurality of first anchors both are sandwiched between inner sides of the Z decoupled masses distributed oppositely; and
a first end of each of the coupling blocks is elastically connected to one of the Z decoupled masses adjacent thereto through the third coupling beam, and a second end of the each of the coupling blocks is elastically connected to one of the first anchors through one of the fourth coupling beams.

As an improvement, the plurality of first anchors are located in a central region of the substrate, and the plurality of coupling blocks are distributed oppositely along the y-axis direction on two sides of the plurality of first anchors.

As an improvement, the fully-decoupled three-axis MEMS gyroscope further includes a plurality of second anchors and a plurality of first guide beams;
the plurality of second anchors are fixed to the substrate and arranged at corner ends of the substrate; and
each of the second anchors is elastically connected to the driving structure adjacent thereto through a corresponding one of the first guide beams.

As an improvement, the fully-decoupled three-axis MEMS gyroscope further includes a plurality of second connecting beams and a plurality of third anchors fixed to the substrate;
each of the third anchors is elastically connected to one side of the X/Y proof mass adjacent thereto facing one of the Z proof masses through a corresponding one of the second connecting beams; and
the plurality of third anchors and the plurality of second connecting beams are annularly arranged at intervals outside the Z decoupled masses.

As an improvement, the fully-decoupled three-axis MEMS gyroscope further includes a plurality of second guide beams and a plurality of fourth anchors fixed to the substrate; and
each of the fourth anchors is elastically connected to one of the Z decoupled masses through one of the second guide beams.

Another aspect of the embodiments of the present disclosure provides an electronic product including the fully-decoupled three-axis MEMS gyroscope described above.

For the fully-decoupled three-axis MEMS gyroscope and the electronic product of the embodiments of the present disclosure, the X/Y proof mass is annularly arranged outside the Z proof masses, the driving structures, and the Z decoupled masses, and for the Z proof masses, the detection mode and the driving mode are in-plane translation motion, which does not affect its Coriolis effect transformation; for the X/Y proof mass, the Z proof masses are arranged at places where the Coriolis transformation rate of the X/Y proof mass is low, improving the Coriolis transformation rate of X/Y proof mass, being capable of maximizing the utilization of chip area, reducing chip size at the same performance, and reducing cost. By providing the Z decoupled masses, the displacement of the Z proof mass can be eliminated in the driving mode, such that the Z detection mode is completely decoupled from the X/Y detection mode, effectively reducing coupling error. A Z detection is decoupled from the Z masses, so that the Z detection has displacement only in the detection mode, effectively reducing orthogonal error and improving the detection precision of the gyroscope. The Z decoupled masses can greatly reduce the displacement at the Z detection electrodes in the driving mode, reducing the items that interfere with the detection value, and improving the detection precision of the gyroscope. For the gyroscope of the present embodiment, the mass ratio shared by drive and detection is high, effectively improving the transformation of the Coriolis force and enhancing the sensitivity of the gyroscope.

### BRIEF DESCRIPTION OF DRAWINGS

FIG. 1 is a structural schematic diagram of a fully-decoupled three-axis MEMS gyroscope of an embodiment of the present disclosure;

FIG. 2 is an enlarged view of an area A in FIG. 1;

FIG. 3 is an enlarged view of an area B in FIG. 1;

FIG. 4 is a structural schematic diagram of the fully-decoupled three-axis MEMS gyroscope of the embodiment of the present disclosure, in which out-of-plane X/Y out-of-detection plane electrodes, Z in-detection plane electrodes, and in-plane driving electrodes are added;

FIG. 5 is a side view of FIG. 4;

FIG. 6 is a structural schematic diagram of the fully-decoupled three-axis MEMS gyroscope of the embodiment of the present disclosure in a driving mode;

FIG. 7 is a structural schematic diagram of the fully-decoupled three-axis MEMS gyroscope of the embodiment of the present disclosure in an x detection mode;

FIG. 8 is a structural schematic diagram of the fully-decoupled three-axis MEMS gyroscope of the embodiment of the present disclosure in a y detection mode; and

FIG. 9 is a structural schematic diagram of the fully-decoupled three-axis MEMS gyroscope of the embodiment of the present disclosure in a z detection mode.

### DESCRIPTION OF EMBODIMENTS

For those skilled in the art to better understand the technical solutions of the embodiments of the present disclosure, the embodiments of the present disclosure are further described in detail below in conjunction with the accompanying drawings and specific implementations.

To facilitate illustration of the fully-decoupled three-axis MEMS gyroscope of the embodiments of the present disclosure, an x-y-z-axis three-dimensional coordinate system is established, with three directions being an x-axis direction, a y-axis direction, and a z-axis direction perpendicular to both the x-axis and the y-axis (that is, an out-of-plane direction). Where a plane on which the x-axis and the y-axis are located is defined as a reference plane.

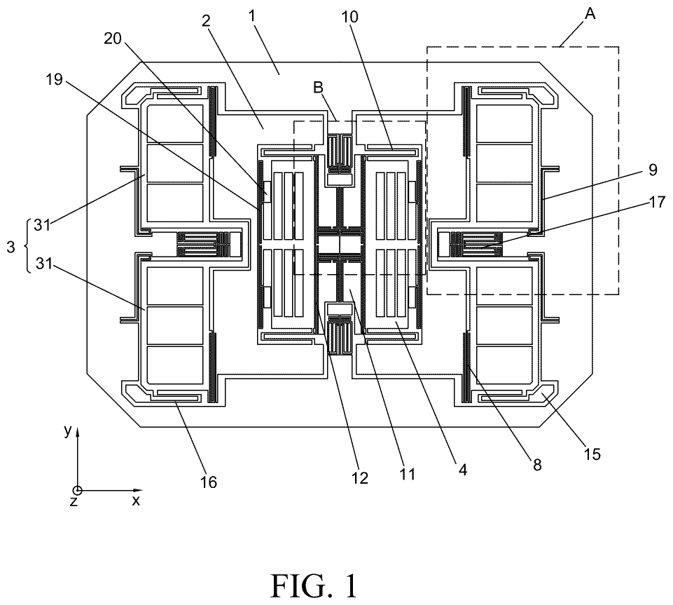

As shown in FIG. 1, an aspect of the embodiments of the present disclosure provides a fully-decoupled three-axis MEMS gyroscope including a substrate (not shown in the figure), an X/Y proof mass 1, a plurality of Z proof masses 2, a plurality of driving structures 3, and a plurality of Z decoupled masses 4 respectively fixed to the substrate, where the X/Y proof mass 1 is annularly arranged outside the plurality of Z proof masses 2, the plurality of driving structures 3, and the plurality of Z decoupled masses 4. It should be noted that, in the present embodiment, the X/Y proof mass is an integrally formed structure, the X/Y proof mass as a whole is annularly arranged outside the plurality of Z proof masses 2, the plurality of driving structures 3, and the Z plurality of decoupled masses 4.

The plurality of Z proof masses 2 are arranged oppositely along the x-axis direction. The plurality of driving structures 3 are arranged oppositely along the x-axis direction outside the plurality of Z proof masses 2. The plurality of Z-decoupled masses 4 are arranged oppositely along the x-axis direction at inner sides of the plurality of Z-proof masses 2. Where the X/Y proof mass 1 is elastically connected to the driving structures 3 adjacent thereto, each of the Z proof masses 2 is elastically connected to one of the driving structures 3 adjacent thereto, and each of the Z decoupled masses 4 is elastically connected to one of the Z proof masses 2 adjacent thereto.

It should be noted that, in the present embodiment, the X/Y proof mass is an integrally formed structure, the X/Y proof mass as a whole is annularly arranged outside the plurality of Z proof masses 2, the plurality of driving structures 3, and the plurality of Z decoupled masses 4.

The fully-decoupled three-axis MEMS gyroscope of the present embodiment adopts an optimized arrangement, with the X/Y proof mass 1 annularly arranged on the outermost side and the driving structures 3 and the Z proof masses 2 arranged inside a ring, and has the following advantage: for the Z proof mass 2, both the detection mode and the driving mode are in-plane translational motion, and the arrangement of the X/Y proof mass 1 inside or outside the ring does not affect its Coriolis effect transformation. For the X/Y proof mass 1, the Coriolis force formula for the in-plane and out-of-plane rotation modes is:. It can seen from the formula that the larger the radius, the greater the Coriolis force. Therefore, the Coriolis transformation rate is high outside the X/Y proof mass 1, while the Coriolis transformation rate is low at an inner side of the X/Y proof mass 1. Based on this, arranging the Z proof masses 2 at places where the Coriolis transformation rate of the X/Y proof mass 1 is low can maximize the utilization of chip area, reduce chip size at the same performance, and reduce cost.

It should be further noted that, in the present embodiment, the number of the Z proof masses 2 is two, the Z proof masses 2 are arranged oppositely along the x-axis and located in a central region of the substrate. The number of the driving structures 3 is two, as shown in FIG. 1, the two driving structures 3 are arranged oppositely along the x-axis and are respectively located outside the Z proof masses 2. The number of the Z decoupled masses 4 is four. Every two Z decoupled masses 4 are distributed up and down as one group, and the two groups of Z decoupled masses 4 are arranged oppositely along the x-axis and respectively located at inner sides of the Z proof masses 2.

Where the number of the Z proof masses 2, the number of the driving structures 3, and the number of the Z decoupled masses 4 are not specifically limited in the present embodiment, and may be selected according to actual needs.

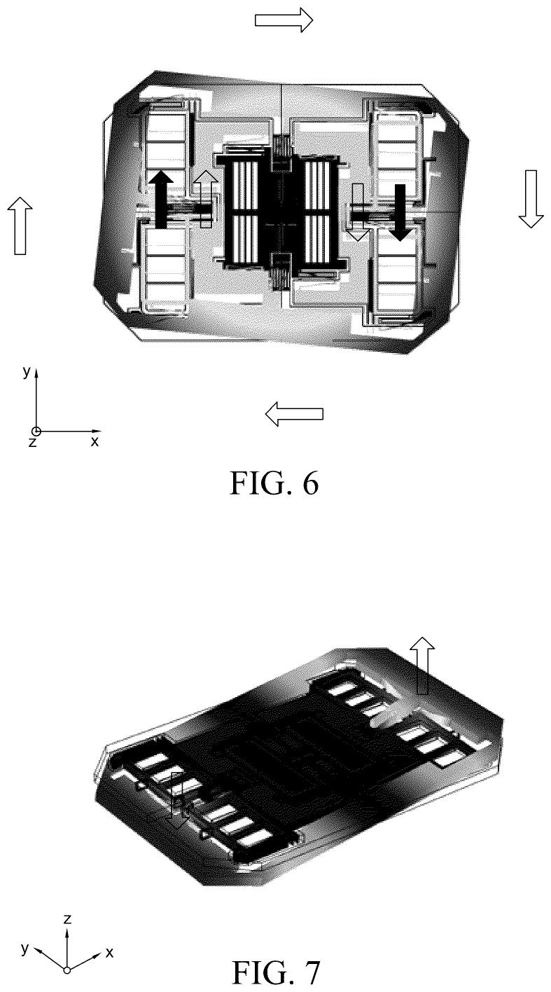

Specifically, in the present embodiment, the fully-decoupled three-axis MEMS gyroscope has four operating modes, namely, a driving mode, an x-axis detection mode, a y-axis detection mode, and a z-axis detection mode.

Where, when the fully-decoupled three-axis MEMS gyroscope detects angular velocity, the gyroscope can firstly be put in the driving mode. As shown in FIG. 6, in the driving mode, one of the two driving structures 3 translates along the positive direction of the y-axis, while the other of the two driving structures 3 translates along the negative direction of the y-axis. In other words, the two driving structures 3 move in opposite directions (the movement directions of the two driving structures 3 are shown by black arrows in FIG. 6). At this point, the two driving structures 3 can respectively drive the two Z proof masses 2 adjacent thereto to respectively move along the positive direction and the negative direction of the y-axis towards two opposite directions, and the two driving structures 3 can drive the X/Y proof mass 1 to rotate, where the movement directions of the X/Y proof mass 1 and the Z proof masses 2 are shown by white arrows in FIG. 6).

In the driving mode, the Z proof masses 2 follow the driving structures 3 to move in the y-axis direction, each of the Z proof masses 2 is elastically connected to the Z decoupled masses 4 through a “U” shaped third coupling beam 12 and the second guide beams 19. The rigidity of the third coupling beam 12 and the second guide beams 19 in the y-axis direction is much larger than the rigidity in the x-axis direction, and thus the displacement of the Z decoupled masses 4 is much smaller than the displacement of the Z proof masses 2 in the driving mode. Therefore, the displacement of the Z proof masses can be eliminated in the driving mode by providing the Z decoupled masses.

As shown in FIG. 7, when the fully-decoupled three-axis MEMS gyroscope is subjected to angular velocity in the x-axis direction, the X/Y proof mass 1 is subjected to the action of a Coriolis force in the z-axis direction (shown by the arrows in FIG. 7) to excite the x-axis detection mode, such that out-of-plane vibration displacement (i.e., vibration displacement toward the outside of the reference plane) along the z-axis direction is generated by the X/Y proof mass 1 on the two opposite sides along the x-axis direction. The angular velocity of the fully-decoupled three-axis MEMS gyroscope about the x-axis can be obtained by detecting the out-of-plane vibration displacement along the z-axis direction of the X/Y proof mass 1 on the two opposite sides along the x-axis direction.

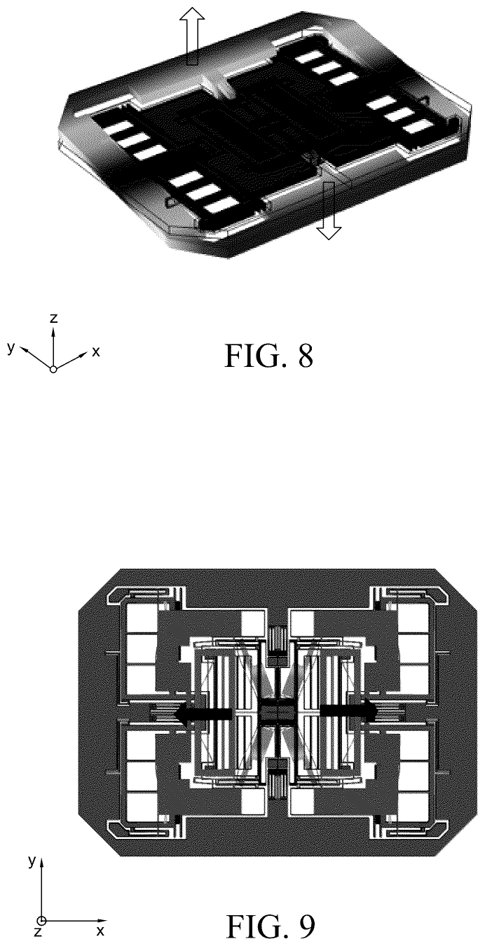

As shown in FIG. 8, when the fully-decoupled three-axis MEMS gyroscope is subjected to angular velocity in the y-axis direction, the X/Y proof mass 1 is subjected to the action of a Coriolis force in the z-axis direction (shown by the arrows in FIG. 8) to excite the y-axis detection mode, such that out-of-plane vibration displacement (i.e., vibration displacement toward the outside of the reference plane) along the z-axis direction is generated by the X/Y proof mass 1 on the two opposite sides along the y-axis direction. The angular velocity of the fully-decoupled three-axis MEMS gyroscope about the y-axis can be obtained by detecting the out-of-plane vibration displacement along the z-axis direction of the X/Y proof mass 1 on the two opposite sides along the y-axis direction.

As shown in FIG. 9, when the fully-decoupled three-axis MEMS gyroscope is subjected to angular velocity in the z-axis direction, the Z proof mass 2 is subjected to the action of a Coriolis force in the x-axis direction (shown by the arrows in FIG. 9) to excite the z-axis detection mode, and under the action of the Coriolis force along the x-axis direction, the Z proof masses 2 and the Z decoupled masses 4 are driven to generate in-plane vibration displacement (i.e., vibration displacement in the reference plane) along the x-axis direction. The angular velocity of the fully-decoupled three-axis MEMS gyroscope about the z-axis can be obtained by detecting the in-plane vibration displacement of the Z proof masses 2 and the Z decoupled masses 4 along the x-axis direction.

For the fully-decoupled three-axis MEMS gyroscope of the embodiment of the present disclosure, the X/Y proof mass is annularly arranged outside the Z proof masses, the driving structures, and the Z decoupled masses, and for the Z proof masses, the detection mode and the driving mode are in-plane translation motion, which does not affect its Coriolis effect transformation; for the X/Y proof mass, the Z proof masses are arranged at places where the Coriolis transformation rate of the X/Y proof mass is low, improving the Coriolis transformation rate of X/Y proof mass, being capable of maximizing the utilization of chip area, reducing chip size at the same performance, and reducing cost. By providing the Z decoupled masses, the displacement of the Z proof mass can be eliminated in the driving mode, such that the Z detection mode is completely decoupled from the X/Y detection mode, effectively reducing coupling error. A Z detection is decoupled from the Z masses, so that the Z detection has displacement only in the detection mode, effectively reducing orthogonal error and improving the detection precision of the gyroscope. The Z decoupled masses can greatly reduce the displacement at the Z detection electrodes in the driving mode, reducing the items that interfere with the detection value, and improving the detection precision of the gyroscope. For the gyroscope of the present embodiment, the mass ratio shared by drive and detection is high, effectively improving the transformation of the Coriolis force and enhancing the sensitivity of the gyroscope.

Exemplarily, as shown in FIG. 1, the X/Y proof mass is symmetrically arranged with respect to each of the x-axis direction and the y-axis direction. Specifically, the upper and lower parts of the X/Y proof mass have the same shape, and the left and right parts of the X/Y proof mass also have the same shape.

The plurality of Z proof masses 2 arranged oppositely are symmetrically distributed with respect to the y-axis direction, and each of the Z proof masses 2 is symmetrically distributed with respect to the x-axis direction. Specifically, in the present embodiment, the two Z proof masses 2 are symmetrically distributed with respect to the y-axis direction.

The plurality of driving structures 3 arranged oppositely are symmetrically distributed with respect to each of the x-axis direction and the y-axis direction. Specifically, as shown in FIG. 1, in the present embodiment, two driving structures 3 distributed oppositely along the x-axis direction are included, where each of the driving structures 3 includes two driving members 31 symmetrically distributed along the y-axis direction. That is, the four driving members 31 are symmetrically distributed with respect to each of the x-axis direction and the y-axis direction.

The plurality of Z decoupled masses 4 arranged oppositely are symmetrically distributed with respect to each of the x-axis direction and the y-axis direction. As shown in FIG. 1, the number of the Z decoupled masses 4 is four, every two Z decoupled masses 4 are distributed up and down as one group, and the two groups of Z decoupled masses 4 are arranged oppositely along the x-axis. In other words, the four Z decoupled masses 4 are symmetrically distributed with respect to each of the x-axis direction and the y-axis direction.

For the fully-decoupled three-axis MEMS gyroscope in the present embodiment, the X/Y proof mass and the gyroscope sensitive masses both adopt a symmetrical layout, which facilitates achieving differential detection. The gyroscope driving mode is differential driving, which is capable of improving the stability and impact resistance of gyroscope driving. The gyroscope's three (xyz) axes detection modes can all achieve inverse vibration, and thus gyroscope differential detection can be achieved, effectively being immune to the effects of acceleration shock and orthogonal error. In addition, the mass ratio shared by drive and detection is high, effectively improving the transformation of the Coriolis force and enhancing the sensitivity of the gyroscope.

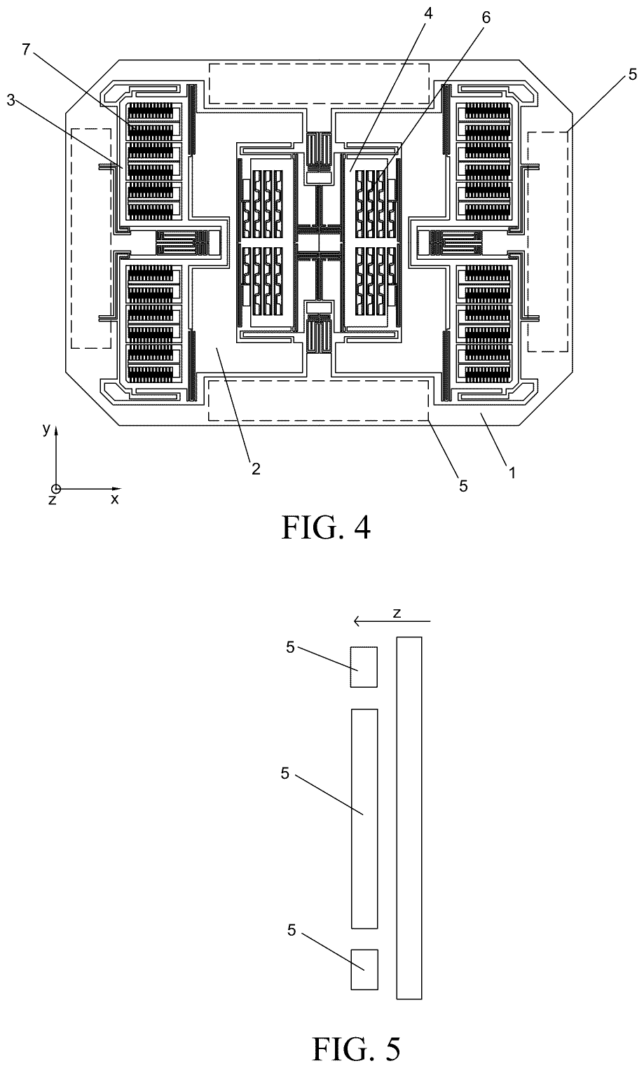

Exemplarily, as shown in FIG. 4 and FIG. 5, the fully-decoupled three-axis MEMS gyroscope further includes a plurality of X/Y out-of-detection plane electrodes 5, a plurality of Z in-detection plane electrodes 6, and a plurality of in-plane driving electrodes 7.

The plurality of X/Y out-of-detection plane electrodes 5 are arranged along the x-axis direction and the y-axis direction, respectively, on one side of the X/Y proof mass 1 facing away from the substrate. Specifically, in the present embodiment, the number of the X/Y out-of-detection plane electrodes 5 is 4, and the X/Y out-of-detection plane electrodes 5 are respectively arranged on the top, bottom, left, and right of the X/Y proof mass 1. The 4 X/Y out-of-detection plane electrodes are symmetrically distributed with respect to each of the x-axis direction and the y-axis direction.

Each of the Z in-detection plane electrodes 6 is arranged on one side of one of the Z-decoupled masses corresponding thereto facing away from the substrate. Specifically, in the present embodiment, the number of the Z in-detection plane electrodes 6 is 4, and each of the Z in-detection plane electrodes 6 is arranged on the upper portion of a corresponding Z-decoupled mass 4. The 4 Z in-detection plane electrodes 6 are symmetrically distributed with respect to each of the x-axis direction and the y-axis direction.

Each of the in-plane driving electrodes 7 is arranged on one side of one of the driving structure 3 corresponding thereto facing away from the substrate. In the present embodiment, the number of the in-plane driving electrodes 7 is 4, and each of the in-plane driving electrodes 7 is arranged on the upper portion of a corresponding driving member 31. The 4 in-plane driving electrodes 7 are symmetrically distributed with respect to each of the x-axis direction and the y-axis direction.

For the fully-decoupled three-axis MEMS gyroscope of the present embodiment, the X/Y detection out-of-plane electrodes 5, the Z detection in-plane electrodes 6, and the in-plane driving electrodes 7 all adopt a symmetrical distribution, and the actual operating states are opposite motion, which facilitates achieving differential detection.

Specifically, as shown in FIG. 7, when the fully-decoupled three-axis MEMS gyroscope is subjected to angular velocity in the x-axis direction, the X/Y proof mass 1 is subjected to the action of a Coriolis force in the z-axis direction to excite the x-axis detection mode. The X/Y proof mass 1 generates vibration displacement along the z-axis. At this point, the X/Y detection out-of-plane electrodes 5 arranged above the X/Y proof mass 1 on the two opposite sides along the x-axis direction detect the vibration displacement generated by the X/Y proof mass 1 in the z-axis direction on the two opposite sides along the x-axis direction, and in turn the angular velocity of the gyroscope about the x-axis is obtained.

As shown in FIG. 8, when the fully-decoupled three-axis MEMS gyroscope is subjected to angular velocity in the y-axis direction, the X/Y proof mass 1 is subjected to the action of a Coriolis force in the z-axis direction to excite the y-axis detection mode. The X/Y proof mass 1 generates vibration displacement along the z-axis. At this point, the X/Y detection out-of-plane electrodes 5 arranged above the X/Y proof mass 1 on the two opposite sides along the y-axis direction detect the vibration displacement generated by the X/Y proof mass 1 in the z-axis direction on the two opposite sides along the y-axis direction, and in turn the angular velocity of the gyroscope about the y-axis is obtained.

As shown in FIG. 9, when the fully-decoupled three-axis MEMS gyroscope is subjected to angular velocity in the z-axis direction, the Z proof masses 2 are subjected to the action of a Coriolis force in the x-axis direction to excite the z-axis detection mode. The Z proof masses 2 generate vibration displacement along the x-axis. At this point, the Z detection in-plane electrodes 6 arranged above the Z decoupled masses 4 detects the vibration displacement generated by the Z proof masses 2 along the x-axis, and in turn the angular velocity of the gyroscope about the z-axis is obtained.

Exemplarily, as shown in FIG. 1, the fully-decoupled three-axis MEMS gyroscope further includes first coupling beams 8, second coupling beams 9, and first connecting beams 10.

Each of the Z proof masses 2 is elastically connected to one of the driving structures 3 adjacent thereto through the first coupling beams 8, and when the driving structure 3 moves, the Z proof mass 2 can be driven to move by the first coupling beams 8.

Specifically, in the present embodiment, the number of the first coupling beams 8 is 4, and each of the first coupling beams 8 is sandwiched between the Z proof mass 2 and the driving member 31. The 4 first coupling beams 8 are symmetrically distributed with respect to each of the x-axis direction and the y-axis direction. The number of the first coupling beams 8 may be selected according to actual needs, which is not specifically limited in the present embodiment. Where the first coupling beams 8 are flexible beams and have elasticity.

The X/Y proof mass 1 is elastically connected to the driving structures 3 adjacent thereto through the second coupling beams 9, and when the driving structures 3 move, the X/Y proof mass 1 can be driven to move by the second coupling beams 9.

Specifically, as shown in FIG. 1, in the present embodiment, the number of the second coupling beams 9 is 4, and each of the second coupling beams 9 is sandwiched between the X/Y proof mass 1 and the driving member 31. The 4 second coupling beams 9 are symmetrically distributed along each of the x-axis direction and the y-axis direction. The number of the second coupling beams 9 is not specifically limited in the present embodiment, and may be selected according to actual needs. The second coupling beams 9 are flexible beams and have elasticity.

Each of the Z decoupled masses 4 is elastically connected to one of the Z proof masses 2 adjacent thereto through one of the first connecting beams 10, and when the Z proof mass 2 moves, the Z decoupled mass 4 can be driven to move by the first connecting beam 10.

Specifically, as shown in FIG. 1, in the present embodiment, the number of the first connecting beams 10 is 4, and each of the first connecting beams 10 is sandwiched between the top of the Z decoupled mass 4 and the Z proof mass 2. The 4 first connecting beams 10 are symmetrically distributed with respect to each of the x-axis direction and the y-axis direction. The first connecting beams 10 are flexible beams and have elasticity.

Exemplarily, as shown in FIG. 1 and FIG. 3, the fully-decoupled three-axis MEMS gyroscope further includes a plurality of coupling blocks 11, a plurality of third coupling beams 12, a plurality of fourth coupling beams 13, and a plurality of first anchors 14 fixed to the substrate.

The plurality of coupling blocks 11 and the plurality of first anchors 14 both are sandwiched between inner sides of the Z-decoupled masses 4 distributed oppositely. A first end of each of the coupling blocks 11 is elastically connected to one of the Z decoupled masses 4 adjacent thereto through the third coupling beam 12, and a second end of the each of the coupling blocks 11 is elastically connected to one of the first anchors 14 through one of the fourth coupling beams 13.

Where the plurality of first anchors 14 are located in a central region of the substrate, and the plurality of coupling blocks 11 are distributed oppositely along the y-axis direction on two sides of the plurality of first anchors 14.

Specifically, as shown in FIG. 1, in the present embodiment, the number of the coupling blocks 11 is 4. Two coupling blocks 11 symmetrically distributed along the y-axis are arranged in the positive direction of the x-axis, and two coupling blocks 11 symmetrically distributed along the y-axis are arranged in the negative direction of the x-axis. The number of the first anchors 14 is 2, and the 2 first anchors 14 are fixed to the central region of the substrate and sandwiched between the coupling blocks 11 distributed up and down. The number of the third coupling beams 12 is 2, and each of the third coupling beams 12 is sandwiched between the Z decoupled masses 4 and the coupling blocks 11 along the y-axis direction. The number of the fourth coupling beams 13 is 2, and the 2 fourth coupling beams 13 are symmetrically distributed with respect to each of the x-axis and the y-axis. A part of each of the fourth coupling beams 13 is bent and distributed between two coupling blocks 11 distributed oppositely along the x-axis, and the remaining part of each of the fourth coupling beams 13 is sandwiched between the coupling blocks 11 and the first anchors 14 along the y-axis.

In the present embodiment, the Z decoupled masses and the coupling blocks may be fixed to the substrate by the plurality of first anchors, to play a role of fixing the Z decoupled masses and the coupling blocks.

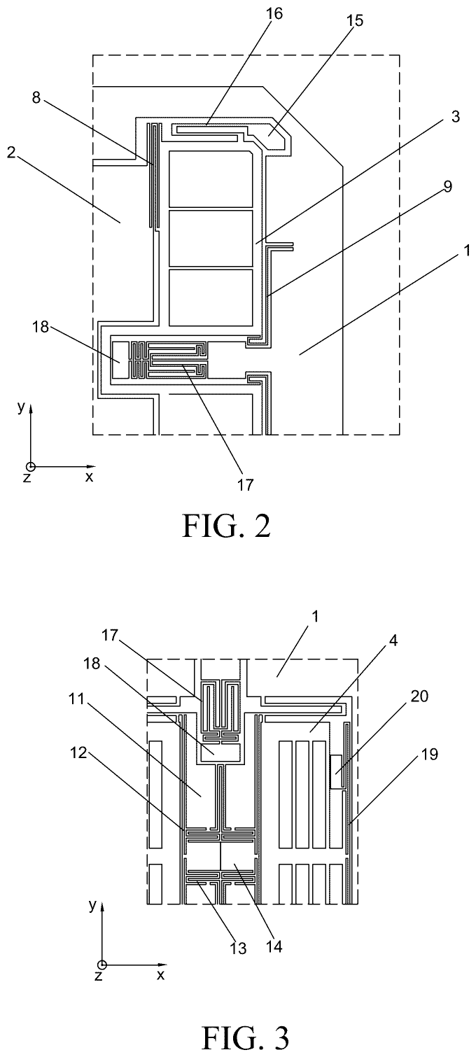

Exemplarily, as shown in FIG. 1 and FIG. 2, the fully-decoupled three-axis MEMS gyroscope further includes a plurality of second anchors 15 and a plurality of first guide beams 16. Each of the second anchors 15 is elastically connected to the driving structure 3 adjacent thereto through a corresponding one of the first guide beams 16.

Specifically, as shown in FIG. 1, the plurality of second anchors 15 are fixed to the substrate and arranged at corner ends of the substrate. The number of the second anchors 15 is 4, and the second anchors 15 are respectively arranged at four corner ends of the substrate. The number of the first guide beams 16 is 4. One end of each of the first guide beams 16 is connected to the second anchor 15 corresponding thereto, and the other end of the each of the first guide beams 16 is connected to the driving member 31 corresponding thereto. Where the first guide beams 16 are flexible beams and have elasticity.

In the present embodiment, the driving structures are fixed to the substrate through the plurality of second anchors and the plurality of first guide beams, to play a role of fixing the driving structures.

Exemplarily, as shown in FIG. 1 and FIG. 2, the fully-decoupled three-axis MEMS gyroscope further includes a plurality of second connecting beams 17 and a plurality of third anchors 18 fixed to the substrate. Each of the third anchors 18 is elastically connected to one side of the X/Y proof mass 1 adjacent thereto facing one of the Z proof masses 2 through a corresponding one of the second connecting beams 17. Where the plurality of third anchors 18 and the plurality of second connecting beams 17 are annularly arranged at intervals outside the Z decoupled masses 4.

Specifically, as shown in FIG. 1, the number of the third anchors 18 is 4, and the third anchors 18 are arranged on the x-axis and the y-axis respectively and are symmetrically distributed with respect to the x-axis direction and the y-axis direction. The number of the second connecting beams 17 is also 4, and each of the second connecting beams 17 is sandwiched between the X/Y proof mass 1 and the third anchor 18. Where one first yielding space is provided on one side of each of the Z proof masses 2 facing the X/Y proof mass 1 along the x-axis direction, one second yielding space is provided on one side of two coupling blocks 11 facing the X/Y proof mass 1 along the y-axis direction, and the four third anchors 18 are respectively provided in the first yielding spaces and the second yielding spaces. The second connecting beams 17 are flexible beams and have elasticity.

In the present embodiment, the X/Y proof mass 2 may be fixed to the substrate by the plurality of second connecting beams and the plurality of third anchors, to play a role of fixing the X/Y proof mass.

Exemplarily, as shown in FIG. 1 and FIG. 3, the fully-decoupled three-axis MEMS gyroscope further includes a plurality of second guide beams 19 and a plurality of fourth anchors 20 fixed to the substrate. Each of the fourth anchors 20 is elastically connected to one of the Z decoupled masses 4 through one of the second guide beams 19.

Specifically, as shown in FIG. 1, the number of the fourth anchors 20 is 4, and each of the fourth anchors 20 is arranged at a corner end of each of the Z decoupled masses 4 and is rectangular. Correspondingly, the number of the second guide beams 19 is also four, and each of the second guide beams 19 is distributed along the y-axis direction and is sandwiched between the Z decoupled mass 4 and the Z proof mass 2. Where the second guide beams 19 are flexible beams and have elasticity.

In the present embodiment, the Z decoupled masses are fixed to the substrate through the plurality of second guide beams and the plurality of fourth anchors, to play a role of fixing the Z decoupled masses.

Another aspect of the embodiments of the present disclosure provides an electronic product including the fully-decoupled three-axis MEMS gyroscope described above. The specific structure of the fully-decoupled three-axis MEMS gyroscope has been described in detail above, which will not be repeated here.

During the operation of the electronic product, the full-decoupled three-axis MEMS gyroscope can calculate the angular velocity of the electronic product, to facilitate control of the electronic product. The full-decoupled three-axis MEMS gyroscope improves the Coriolis transformation rate of the X/Y proof mass, thereby being capable of maximizing the utilization of chip area, reducing chip size at the same performance, reducing cost, effectively reducing coupling error and orthogonal error, and improving the detection precision of the gyroscope. For the gyroscope of the present embodiment, the mass ratio shared by drive and detection is high, effectively improving the transformation of the Coriolis force and enhancing the sensitivity of the gyroscope.

It can be understood that the above implementations are merely exemplary implementations used for illustrating the principles of the embodiments of the present disclosure, but the embodiments of the present disclosure are not limited thereto. For those skilled in the art, various modifications and improvements may be made without departing from the spirit and essence of the embodiments of the present disclosure, and these modifications and improvements are further considered as the protection scope of the embodiments of the present disclosure.

What is claimed is:

1. A fully-decoupled three-axis Micro-Electro-Mechanical System (MEMS) gyroscope, comprising: a substrate, an X/Y proof mass, a plurality of Z proof masses, a plurality of driving structures, and a plurality of Z decoupled masses respectively fixed to the substrate,
wherein the X/Y proof mass is annularly arranged outside the plurality of Z proof masses, the plurality of driving structures, and the plurality of Z decoupled masses; the plurality of Z proof masses are arranged oppositely along an x-axis direction; the plurality of driving structures are arranged oppositely along the x-axis direction outside the plurality of Z proof masses; and the plurality of Z decoupled masses are arranged oppositely along the x-axis direction at inner sides of the plurality of Z proof masses; and
wherein the X/Y proof mass is elastically connected to the driving structures adjacent thereto, each of the Z proof masses is elastically connected to one of the driving structures adjacent thereto, and each of the Z decoupled masses is elastically connected to one of the Z proof masses adjacent thereto.

2. The fully-decoupled three-axis MEMS gyroscope as described in claim 1, wherein the X/Y proof mass is symmetrically arranged with respect to each of the x-axis direction and a y-axis direction;
the plurality of Z proof masses arranged oppositely are symmetrically distributed with respect to the y-axis direction, and each of the Z proof masses is symmetrically distributed with respect to the x-axis direction;
the plurality of driving structures arranged oppositely are symmetrically distributed with respect to each of the x-axis direction and the y-axis direction; and
the plurality of Z decoupled masses arranged oppositely are symmetrically distributed with respect to each of the x-axis direction and the y-axis direction.

3. The fully-decoupled three-axis MEMS gyroscope as described in claim 2, further comprising a plurality of X/Y out-of-detection plane electrodes, a plurality of Z in-detection plane electrodes, and a plurality of in-plane driving electrodes;
wherein the plurality of X/Y out-of-detection plane electrodes are arranged along the x-axis direction and the y-axis direction, respectively, on one side of the X/Y proof mass facing away from the substrate;
each of the Z in-detection plane electrodes is arranged on one side of one of the Z-decoupled masses corresponding thereto facing away from the substrate; and
each of the in-plane driving electrodes is arranged on one side of one of the driving structure corresponding thereto facing away from the substrate.

4. The fully-decoupled three-axis MEMS gyroscope as described in claim 1, further comprising first coupling beams, second coupling beams, and first connecting beams;
wherein each of the Z proof masses is elastically connected to one of the driving structures adjacent thereto through the first coupling beams;
the X/Y proof mass is elastically connected to the driving structures adjacent thereto through the second coupling beams; and
each of the Z decoupled masses is elastically connected to one of the Z proof masses adjacent thereto through one of the first connecting beams.

5. The fully-decoupled three-axis MEMS gyroscope as described in claim 1, further comprising a plurality of coupling blocks, a plurality of third coupling beams, a plurality of fourth coupling beams, and a plurality of first anchors fixed to the substrate;
wherein the plurality of coupling blocks and the plurality of first anchors both are sandwiched between inner sides of the Z decoupled masses distributed oppositely; and
a first end of each of the coupling blocks is elastically connected to one of the Z decoupled masses adjacent thereto through the third coupling beam, and a second end of the each of the coupling blocks is elastically connected to one of the first anchors through one of the fourth coupling beams.

6. The fully-decoupled three-axis MEMS gyroscope as described in claim 5, wherein the plurality of first anchors are located in a central region of the substrate, and the plurality of coupling blocks are distributed oppositely along the y-axis direction on two sides of the plurality of first anchors.

7. The fully-decoupled three-axis MEMS gyroscope as described in claim 1, further comprising a plurality of second anchors and a plurality of first guide beams;
wherein the plurality of second anchors are fixed to the substrate and arranged at corner ends of the substrate; and
each of the second anchors is elastically connected to the driving structure adjacent thereto through a corresponding one of the first guide beams.

8. The fully-decoupled three-axis MEMS gyroscope as described in claim 1, further comprising a plurality of second connecting beams and a plurality of third anchors fixed to the substrate;
wherein each of the third anchors is elastically connected to one side of the X/Y proof mass adjacent thereto facing one of the Z proof masses through a corresponding one of the second connecting beams; and
the plurality of third anchors and the plurality of second connecting beams are annularly arranged at intervals outside the Z decoupled masses.

9. The fully-decoupled three-axis MEMS gyroscope as described in claim 1, further comprising a plurality of second guide beams and a plurality of fourth anchors fixed to the substrate; and
wherein each of the fourth anchors is elastically connected to one of the Z decoupled masses through one of the second guide beams.

10. An electronic product, comprising the fully-decoupled three-axis MEMS gyroscope as described in claim 1.
